(19) United States
(12) Patent Application Publication
(10) Pub. No.: US 2008/0104659 A1
(43) Pub. Date: May 1, 2008

(54) Prioritized real-time data transmission

(76) Inventors: Matthew James West, Salem, OR (US); Paul S. Everest, Albany, OR (US); Arnold W. Larson, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/553,927

(22) Filed: Oct. 27, 2006

(51) Int. Cl. H04N 7/16

(52) U.S. Cl. 725/148

(57) ABSTRACT

Real-time data is transmitted from a transmitter to a receiver. For each frame of the real-time data, portions of the frame are transmitted from the transmitter to the receiver within a time period allocated for transmission of the frame, in order from one or more higher-priority portions of the frame to one or more lower-priority portions of the frame, until the time period allocated for transmission of the frame has expired. The transmitter waits for feedback from the receiver after transmitting each portion of each frame. Not all of the portions of each frame may be transmitted during the time period allocated for transmission of the frame.

### BACKGROUND

Real-time data is commonly transmitted in a variety of different situations. For example, on the Internet, real-time video and/or audio data may be transmitted from a server to a client, so that a user at the client may view the video and/or listen to the audio. Within the home, real-time video and/or audio data may be transmitted from one audio/video device, such as a set-top box, to another audio/video device, such as a display or a receiver, so that a user may view the video rendered by and displayed on the display and/or listen to the audio as rendered by the receiver and output to speakers.

Unlike other types of data transmission, it is important that real-time data be transmitted in a timely manner. For example, real-time video data may be divided into a number of different frames. If a given frame is not received at the appropriate time, display of the real-time video data may be degraded. The display of the video data may be choppy, or be inflicted with other problems. As such, the user viewing the display of the video data may become dissatisfied.

### BRIEF DESCRIPTION OF THE DRAWINGS

FIG. 1 is a block diagram of a representative system within which real-time data transmission occurs, according to an embodiment of the invention.

FIG. 2 is a diagram of a representative frame of real-time data, according to an embodiment of the invention.

FIGS. 3A, 3B, 3C, 3D, and 3E are example diagrams depicting how different image data portions of a frame can result in different levels of rendering quality of the image data of the frame, according to an embodiment of the invention.

FIG. 4 is a diagram depicting example transmission of real-time data, where each frame does not exceed a corresponding time period for transmission regardless of bandwidth constraints, according to an embodiment of the invention.

FIG. 5 is a flowchart of a method for transmitting real-time data from a transmitter to a receiver, according to an embodiment of the invention.

FIG. 6 is a diagram of a transmitter and a receiver in detail, according to an embodiment of the invention.

### DETAILED DESCRIPTION

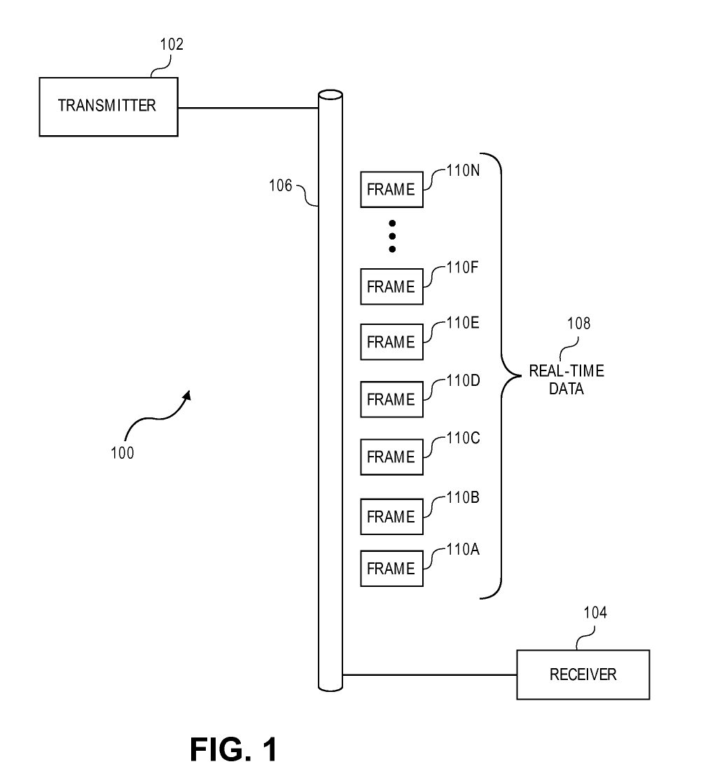

FIG. 1 shows a representative system 100, according to an embodiment of the invention. The system 100 includes a transmitter 102 and a receiver 104 communicatively coupled via a data pipe 106. The transmitter 102 and the receiver 104 may each be implemented in hardware, software, or a combination of hardware and software. For example, each of the transmitter 102 and the receiver 104 may be a general-purpose computing device, such as a desktop or a laptop computer, as well as a dedicated-purpose electronic device, such as an audio/video device.

The data pipe 106 represents a communication connection between the transmitter 102 and the receiver 104. The data pipe 106 may be as simple as a cable directly connecting the transmitter 102 and the receiver 104. Alternatively, the data pipe 106 may represent a more complex packetized connection. For example, the data pipe 106 may be, represent, or include one or more networks, such as the Internet, local-area networks (LAN's), wide-area networks (WAN's), intranets, and extranets, as well as the public switched telephone network (PSTN).

The transmitter 102 transmits real-time data 108 for receipt by the receiver 104. The real-time data 108 may be video data, audio data, or another type of real-time data. Video data, for instance, may include both image data and audio data. The data 108 is real-time data in that the data is to be sent from the transmitter 102 for rendering at the receiver 104 in a real-time manner. For example, real-time video data is sent from the transmitter 102 to the receiver 104 such that as the video data is received at the receiver 104, it is rendered and/or displayed at the receiver 104 in real time. Such transmission of real-time video and/or audio data is commonly referred to as streaming.

By comparison, non-real-time data does not have to be sent from the transmitter 102 for rendering at the receiver 104 in a real-time manner. As one example, email messages are not real-time data. Email messages can be transmitted from a server to a client, for instance, in a non-real-time manner, because it is unimportant for the client to render an email message in real time. Rather, the client typically waits to receive the entire email message before rendering the message, such that at least minor delays in transmission of the email message are acceptable.

In general, for instance, real-time transmission of audio-video data in particular is needed when the transmission of the data is part of a human feedback loop. One example is videoconferencing, where such audio-video data has to be displayed in a timely manner so that a conversation can naturally occur without inordinate delays between questions and replies. Another example is video gaming, in which the viewer (e.g., the player) of the audio-video data has to provide some type of input response via a mouse, joystick, or other type of input device. The response is then reflected back into the audio-video data. If the audio-video delay is too long, gaming performance suffers.

As used herein, the term rendering generally and in a non-limited manner means converting coded data to the required format needed for playing, such as for display on a display device in the case of image data, and for output on an audio device in the case of image data. Rendering can include, for instance, converting image data in one format to the format that a display device actually uses to control the display mechanisms of the display device to display the image data. Similarly, rendering can include converting audio data in one format to the format that an audio device actually uses to control one or more speakers to render the audio data audible. Rendering can be used in ways other than this description as well.

The real-time data 108 is divisible into a number of frames 110A, 110B, 110C, 110D, 110E, 110F, . . . 110N, collectively referred to as the frames 110. The frames 110 of the real-time data 108 are independent of one another, in that each frame is renderable independent of the other frames. That is, the receiver 104, upon receiving one of the frames 110, is able to render the frame, without reference to any of the other frames 110 of the real-time data 108.

In this respect, the frames 110 of the real-time data 108 may be compressed on an individual and separate basis by the transmitter 102 before transmission to the receiver 104. That is, each frame is individually and separately compressed, and thus is independent of the other frames. For instance, the JPEG2000 compression scheme may be employed to individually and separately compress each frame of real-time video image as if each frame were a static image. In this respect, this embodiment of the invention differs from MPEG-2, MPEG-4, and other compression schemes that do not separately and independently compress each frame of video data. Rather, such compression schemes use a delta approach, in which a given frame can be compressed in relation to changed motion relative to a previous base frame, such that the frame is dependent on the previous base frame, and not independent of the base frame.

The remainder of the detailed description is substantially presented in relation to an embodiment of the invention that transmits real-time data 108 from the transmitter 102 to the receiver 104 that is real-time video data. Such real-time video data is presumed to include both image data and audio data. However, other embodiments of the invention are applicable to the transmission of real-time data 108 that is not real-time video data including both image data and audio data. For instance, such other embodiments may relate to real-time data 108 that is real-time video data including just image data and no audio data, to real-time data 108 that is real-time audio data, as well as to other types of real-time data 108 that is not real-time video data or real-time audio data.

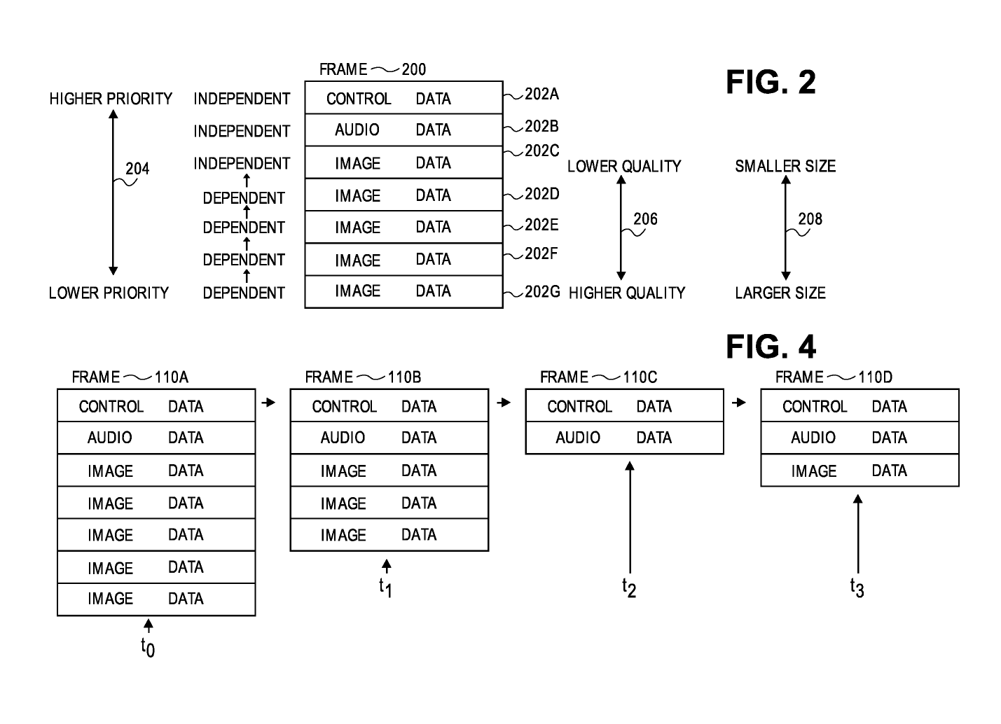

FIG. 2 shows a representative frame 200 of the real-time data 108, according to an embodiment of the invention. The frame 200 may represent any of the frames 110 of the real-time data 108, where the real-time data is real-time video data including both image data and audio data. The frame 200 includes a number of data portions 202A, 202B, 202C, 202D, 202E, 202F, and 202G, collectively referred to as the data portions 202. While there are seven data portions 202 in the frame 200, this is for example purposes only, and there may be more or less than seven data portions 202.

The data portions 202 have corresponding priorities, denoted by the arrow 204, such that the portions 202 range from higher priority to lower priority. The higher priority data portions 202 include a control data portion 202A and an audio data portion 204A. The control data portion 202A may include basic information regarding the frame 200 itself, such as how much of the video data itself has changed, security data, authentication data, remote commands, and so on. The audio data portion 202B includes all the information needed to render the audio information of the frame 200. The higher priority data portions 202A and 202B are independent of other portions of the frame 200, in that they are each renderable independent of the other portions of the frame 200. For example, the audio data portion 202B can be rendered without using any data from the other portions of the frame 200.

The lower priority data portions 202 of the frame 200 include image data portions 202C, 202D, 202E, 202F, and 202G. The image data portion 202C has higher priority than the image data portion 202C, which has higher priority than the image data portion 202D, which has higher priority than the image data portion 202E, which has higher priority than the image data portion 202F, and which finally has higher priority than the image data portion 202G. (The audio data may alternatively be divided over a number of different data portions as well, as is the case with the image data, instead of residing completely within one data portion 202B.) The image data portions represent renderings of the image information of the frame 200 at different qualities, denoted by the arrow 206. Thus, the image data portion 202C includes the data to render the image information of the frame 200 at the lowest quality, whereas the image data portion 202G includes the data to render the image information at the highest quality.

The image data portions 202 of the frame 200 have different data sizes, denoted by the arrow 208. However, the image data portions 202 having different data sizes is for example purposes only, just in relation to the embodiment of the invention being described, and does not limit all embodiments of the invention. For instance, the image data portions 202 may be substantially the same size, or the lowest-quality portions may have larger sizes than the highest-quality portions do.

Therefore, the image data portion 202C in the embodiment of the invention particularly shown in FIG. 2, while representative of rendering the image information of the frame 200 at the lowest quality, has the smallest data size, whereas the image data portion 202G, while representative of rendering the image information of the frame 200 at the highest quality, has the largest data size. Therefore, the image data portion 202G takes longer to be transmitted from the transmitter 102 to the receiver 104 than the image data portion 202F, which takes longer than the image data portion 202E, which takes longer than the image data portion 202D, and which finally takes longer than the image data portion 202C. While there are five image data portions in the frame 200, this is for example purposes only, and there may be more or less than five data image data portions.

The image data portion 202C is independent of the other portions of the frame 200, in that it can be rendered without using any data from the other portions of the frame 200. By comparison, the image data portions 202D, 202E, 202F, and 202G are each additively dependent on other image data portions that have lower quality. For example, the image data portion 202D is rendered in an additive manner based on the data of the image data portion 202C, in that rendering of the image data portion 202D can require the data of the image data portion 202C as well as the image data portion 202D. Likewise, the image data portion 202E is rendered in an additive manner based on the data of the image data portions 202C and 202D, and the image data portion 202F is rendered in an additive manner based on the data of the image data portions 202C, 202D, and 202E. The image data portion 202G is rendered in an additive manner based on the data of the image data portions 202C, 202D, 202E, and 202F.

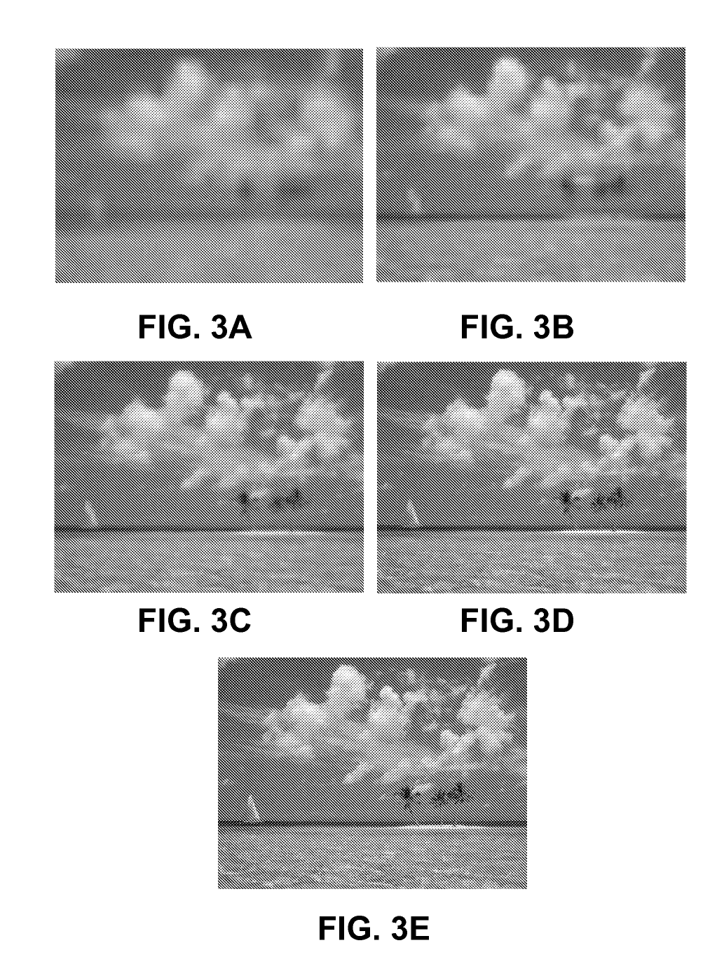

FIGS. 3A, 3B, 3C, 3D, and 3E show example renderings of the image of the frame 200 based on the different image portions of the frame 200, according to an embodiment of the invention. In FIG. 3A, the image of the frame 200 has been rendered just on the basis of the image data portion 202C. As such, the resultingly rendered image is of lowest quality. In FIG. 3B, the image of the frame 200 has been rendered on the basis of the image data portions 202C and 202D, and is of higher quality than in FIG. 3A. In FIG. 3C, the image of the frame 200 has been rendered on the basis of the image data portions 202C, 202D, and 202E, and is of higher quality than in FIG. 3B. In FIG. 3D, the image of the frame 200 has been rendered on the basis of the image data portions 202C, 202D, 202E, and 202F, and is of higher quality than in FIG. 3C. In FIG. 3E, the image of the frame has been rendered on the basis of all the image data portions 202C, 202D, 202E, 202F, and 202G, and is of the highest quality.

Therefore, the more of the image data portions of the frame 200 that are available for rendering the image of the frame 200, the better the resulting quality of the image. The images of the frame 200 of FIGS. 3A-3E correspond to the different image data portions of the frame being compressed in one embodiment using the JPEG2000 compression scheme at five different levels, where a higher quality level of compression is based on the data of all lower quality levels of compression. In general, the lower quality levels of compression include less data, and the data that they do include relate to lower frequency information in the frequency domain of an image, whereas the higher quality levels of compression include more data, which relate to higher frequency information in the frequency domain of the image.

In one embodiment of the invention, each of the frames 110 of the real-time data 108 are to be transmitted by the transmitter 102 to the receiver 104 within a given period of time. If any of the frames 110 exceeds its correspondingly allocated time period for transmission, rendering quality of the real-time data 108 may suffer. For instance, if some of the frames 110 take too long to be transmitted from the transmitter 102 to the receiver 104, rendering of the real-time data 108, in the case where the real-time data 108 is real-time video data, may be choppy. That is, the image data may constantly stop and restart, and the audio data may be garbled and thus unintelligible to a user.

Based on the bandwidth afforded by the data pipe 106, the transmitter 102 may expect to be able to send the frames 110 of the real-time data 108 to the receiver 104 at a given rate, such that each of the frames 110 is allocated a corresponding period of time for transmission. However, bandwidth is not constant. Network and other external as well as internal factors can result in the bandwidth periodically decreasing. During such lengths of time, transmission of the frames 110 can take longer than their corresponding time periods. As such, whereas at first the real-time 108 data may be rendered at acceptable quality, subsequent delays in the receiver 104 receiving some of the frames 110 can result in unacceptable rendering.

Therefore, embodiments of the invention gracefully decrease the number of the data portions 202 of the frames 110 that are sent by the transmitter 102 to the receiver 104 in response to changing bandwidth of the data pipe 106 between the transmitter 102 and the receiver 104. As such, in at least some embodiments, transmission of none of the frames 110 exceeds their corresponding time periods. To ensure that transmission of the frames 110 does not exceed their corresponding time periods, the transmitter 102 begins transmitting the next frame when the time period for the current frame has expired, regardless if all the data portions of the current frame have been transmitted. The result is that rendering of the image data degrades more gracefully than in the prior art, ensuring a more acceptable experience for the user.

FIG. 4 shows an example transmission of some of the frames 110 of the real-time data 108 in this respect, according to an embodiment of the invention. Each of the frames 110 is instantiated as the frame 200, having the data portions 202 as have been described. Each of the frames 110 is allocated the same period of time during which the frame is to be transmitted from the transmitter 102 to the receiver 104. Thus, the frame 110A is to be transmitted at time t₀, the frame 110B is to be transmitted at time t₁, the frame 110C is to be transmitted at time t₂, and the frame 110D is to be transmitted at time t₃, where t₁-t₀ equals t₂-t₁, which equals t₃-t₂.

In the first time period, the bandwidth of the data pipe 106 between the transmitter 102 and the receiver 104 may be sufficiently high to enable all of the data portions of the frame 110A to be transmitted, including the control data portion, the audio data portion, and all the image data portions. As such, the audio data of the frame 110A is properly rendered, and the image data of the frame 110A is rendered at the highest quality. In the next time period, the bandwidth of the data pipe 106 may degrade slightly, such that only the control data portion, the audio data portion, and just three of the image data portions of the frame 110B may be able to be transmitted. As such, the audio data of the frame 110B is again properly rendered, but the image data of the frame 110B is rendered at slightly lower quality.

Thereafter, the bandwidth of the data pipe 106 may degrade more significantly, such that only the control data portion and the audio data portion, and none of the image data portions, of the frame 110C may be able to be transmitted from the transmitter 102 to the receiver 104. While the audio data of the frame 110C is still properly rendered, the image data of the frame 110C cannot be rendered at all. In the final time period of this example, the bandwidth of the data pipe 106 may improve slightly, so that the control data portion, the audio data portion, and now one image data portion of the frame 110D is able to be transmitted. As before, the audio data of the frame 110D is properly rendered, but the image data of the frame 110D is rendered at the lowest quality.

Three notes are provided regarding the example transmission of FIG. 4. First, assuming that there is a sufficiently low amount of bandwidth available within the data pipe 106 between the transmitter 102 and the receiver 104, the audio data is always transmitted and thus can be properly rendered. Therefore, even if at times the image data cannot be rendered or is rendered at lower quality, the rendering of the real-time data 108 is still better than in the prior art, and the user is able to hear the audio properly at all times, without any choppiness or garbling. For example, if the user is streaming a newscast over the Internet, even if the image data is rendered at lower quality, the user is still able to completely understand the audio data, which generally consumes less bandwidth than the image data does.

Second, the rendering of the image data gracefully degrades based on the amount of bandwidth available within the data pipe 106 between the transmitter 102 and the receiver 104. When there is a larger amount of bandwidth available, more of the image data portions of a given frame are transmitted for higher-quality rendering, and when there is a smaller amount of bandwidth available, less (or none) of the image data portions of a given frame are transmitted for lower-quality rendering. However, even as the rendering quality of the image data fluctuates in response to available bandwidth within the data pipe 106, the image data rendering is not choppy, since no frame is permitted to exceed its allocated period of time for transmission, regardless of available bandwidth. As such, the user is provided with a better image data rendering experience than in the prior art.

Third, the example transmission of FIG. 4 represents a prioritized transmission of the real-time data 108 within the data pipe 106 between the transmitter 102 and the receiver 104. The control data and the audio data portions of each frame have priority over the image data portions of the frame. If there is insufficient time to transmit all the data portions of a frame from the transmitter 102 to the receiver 104, desirably at least the control data and the audio data portions of the frame are transmitted. Likewise, the image data portions of each frame are prioritized from lesser quality/smaller size to higher quality/larger size. If there is insufficient time to transmit all the image data portions of a frame from the transmitter 102 to the receiver 104, desirably at least one or more of the lesser quality image data portions of the frame are transmitted, so that image data rendering at least at some quality level can occur on a frame-by-frame basis without delay.

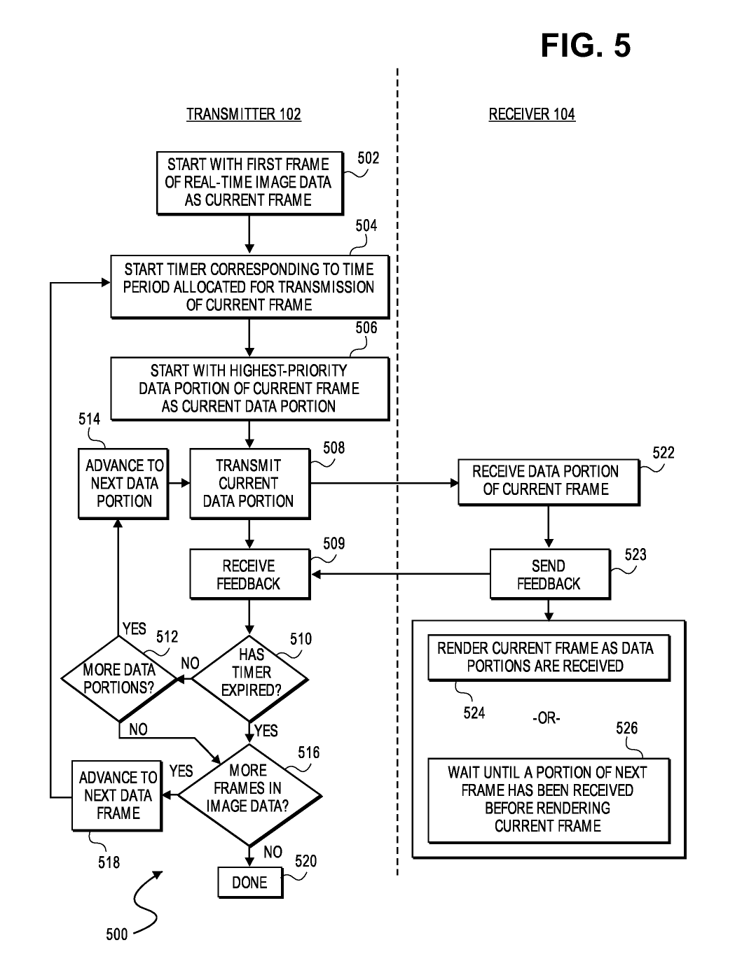

FIG. 5 shows a method 500 for transmitting the real-time data 108 from the transmitter 102 to the receiver 104, according to an embodiment of the invention. Some parts of the method 500, to the left of the dotted line, are performed by the transmitter 102. Other parts of the method 500, to the right of the dotted line, are performed by the receiver 104.

The first frame 110A of the frames 110 of the real-time data 108 is started with as the current frame (502). A timer is started that corresponds to the time period allocated for transmission of the current frame (504). In general, the time period allocated for the transmission of each frame of the frames 110 is the same, and is based on the frame rate of the real-time data 108. For example, if the real-time data 108 is encoded at 24 frames per second, then each frame is allocated 41.7 milliseconds for transmission to the receiver 104, so that the real-time data 108 is properly rendered in real time. In one embodiment, the timer counts down from its initially set time. When the timer has expired, such as by reaching zero, this means that the current frame is no longer to be transmitted, and instead transmission of the next frame is to begin, regardless of whether all the data portions of the current frame have been transmitted.

The highest-priority data portion of the current frame is started with as the current data portion of the current frame of the real-time data 108 (506). For instance, in relation to the representative frame 200, the control data portion 202A is the highest-priority data portion. The current data portion is transmitted from the transmitter 102 to the receiver 104 over the data pipe 106 (508). The transmitter 102 receives feedback from the receiver 104 indicating at least that the receiver 104 has received the current data portion (509). If the timer has not yet expired (510), and there are more data portions within the current frame that have not yet been transmitted (512), then the current data portion is advanced to the next highest-priority data portion of the current frame (514), and the method 500 repeats at part 508. Therefore, in relation to the representative frame 200, the data portions 202 are transmitted in this order: 202A, 202B, 202C, 202D, 202E, 202F, and 202G, corresponding to their priorities in relation to one another.

It is noted that parts 509 and 510 can be performed in unison and/or in a combined manner, which is not particularly reflected in FIG. 5, as follows. The receiver 104 may not properly send feedback to the transmitter 102. In this case, the transmitter 102 does not wait indefinitely at part 509. Rather, once the timer has expired in part 510, the transmitter 102 stops waiting at part 509, such that the transmitter 102 proceeds to part 516. In other words, part 509 can be performed as the transmitter 102 receiving feedback or the timer of part 510 expiring. In the case where the timer expires, the method 500 proceeds from part 509 to part 510, and then to part 516.

At any point when the timer has expired (510), the method 500 immediately proceeds to part 516. That is, even if not all the data portions of the current frame have been transmitted to the receiver 104, when the timer for the current frame expires, the method 500 nevertheless proceeds to part 516, such that some of the data portions of the current frame may never be transmitted to the receiver 104. The method 500 also proceeds to part 516 where all the data portions of the current frame have been transmitted to the receiver 104, and there are no more data portions of the current frame to be transmitted (512). That is, all of the data portions of the current frame may be transmitted to the receiver 104 before the timer for the current frame expires, such that the method 500 proceeds to part 516 in this situation as well.

If there are more frames within the real-time image data 108 that have to be transmitted to the receiver 104 (516), then the current frame is advanced to the next frame (518), and the method 500 repeats at part 504. Otherwise if there are no more frames within the image data 108 that have to be transmitted to the receiver 104 (516), the method 500 is finished as to the transmitter 102 (520). The method 500 thus ensures that no frame of the real-time image data 108 takes more than its allocated time period to be transmitted to the receiver 104.

As to the receiver 104, as the transmitter 102 transmits data portions of frames, the receiver 104 receives the data portions (522), and sends feedback to the transmitter 102 that the data portions have been received (523). The receiver 104 renders the real-time data 108 on a real-time, frame-by-frame basis, as opposed to, for instance, waiting for all the frames to be transferred before rendering the real-time data 108. In one embodiment, the receiver 104 renders each frame as the data portions of the frame are received (524). That is, each time a data portion of a frame is received, the data portion is rendered, without waiting for all the data portions of the frame to be received. In another embodiment, the receiver 104 waits until a data portion of the next frame has been received before rendering a given frame (526), as is the case where the JPEG2000 compression scheme is being employed. That is, the receiver 104 first waits until all the data portions of a frame that will be transmitted by the transmitter 102 are received before rendering the frame. It is noted that for a given frame, the receiver 104 may not receive all the data portions of the frame, but rather just those data portions that the transmitter 102 is able to transmit during the period of time allocated for transmission of the frame. In such a situation, the receiver may modify an attribution portion of the image data before rendering it, as can be appreciated by those of ordinary skill within the art.

Other methodologies for frame rendering can also be employed. For example, if all of the data portions of a given frame have been received, the receiver 104 may render the frame without having to wait for a data portion of the next frame to be received. As another example, rather than using a data portion of the next frame as a trigger to cause rendering of the current frame, a timer can be used at the receiver 104 to trigger current frame render. Once the timer has expired, the current frame is rendered, regardless of which of the data portions of that frame have been received.

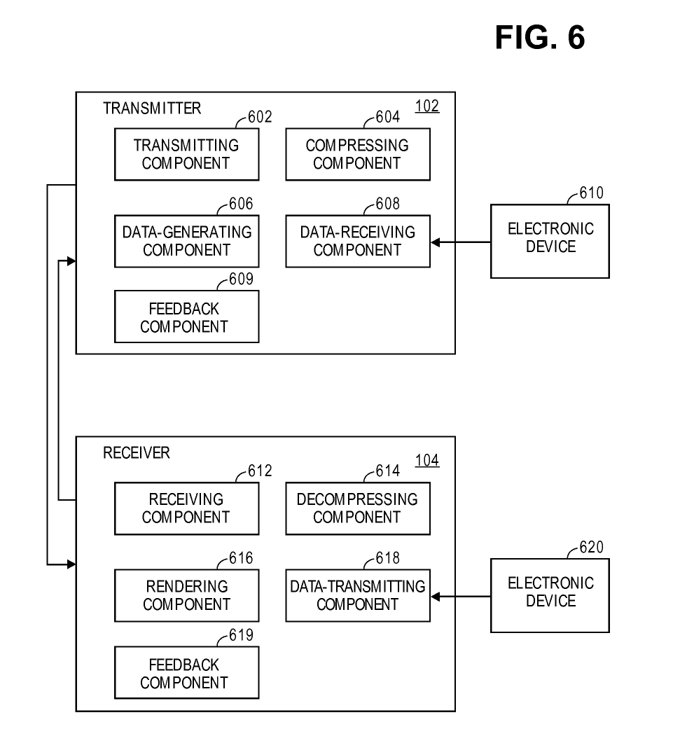

FIG. 6 shows the transmitter 102 and the receiver 104 in more detail according to an embodiment of the invention. The transmitter 102 and the receiver 104 together can be considered an electronic apparatus or device, such as a system including the transmitter 102 and the receiver 104. Alternatively, just the transmitter 102 or just the receiver 104 by itself can be considered an electronic apparatus or device.

The transmitter 102 includes a transmitting component 602, which may be implemented in hardware, software, or a combination of hardware and software. The transmitting component 602 transmits each of the frames 110 of the real-time data 108 within an allocated time period to the receiver 104, in the order of the higher-priority data portions of a frame to the lower-priority data portions of the frame. The transmitter 102 may further include a compressing component 604, which may be implemented in hardware, software, or a combination of hardware and software. The compressing component 604 compresses the real-time data 108 on a frame-by-frame basis, such as by using the JPEG2000 approach, as has been described, before the real-time data 108 is transmitted to the receiver 104.

The transmitter 102 may also include a data-generating component 606, which may be implemented in hardware, software, or a combination of hardware and software. The data-generating component 606 generates the real-time data 108 prior to compression by the compressing component 604 and prior to transmission by the transmitting component 602. Additionally, or alternatively, the transmitter 102 may include a data-receiving component 608, which may be implemented in hardware, software, or a combination of hardware and software. The data-receiving component 608 receives the real-time data 108, prior to compression by the compressing component 604 and prior to transmission by the transmitting component 602, from an external electronic device 610, such as a set-top box, another type of audio/video device, or a different type of electronic device altogether. In such an embodiment, the electronic device 610 generates the real-time data 108.

The receiver 104 includes a receiving component 612, which may be implemented in hardware, software, or a combination of hardware and software. The receiving component 612 receives each of the frames 110 of the real-time data 108 from the transmitter 102 on a frame-by-frame, and a data portion-by-data portion, basis. The receiver 104 may further include a decompressing component 614, which may be implemented in hardware, software, or a combination of hardware and software. The decompressing component 614 decompresses the real-time data 108 on a frame-by-frame, and/or a data portion-by-data portion, basis, once the frame and/or data portion in question has been received from the transmitter 102. Alternatively, decompression may be considered as or performed as a part of rendering.

The receiver 104 may thus include a rendering component 616, which may be implemented in hardware, software, or a combination of hardware and software. The rendering component 616 renders the real-time data 108 on a frame-by-frame, and/or a data portion-by-data portion, basis, once the frame and/or data portion in question has been received from the transmitter 102. Additionally, or alternatively, the receiver 104 may include a data-transmitting component 618, which may be implemented in hardware, software, or a combination of hardware and software. The data-transmitting component 618 transmits the real-time data 108 on a frame-by-frame, and/or a data portion-by-data portion, basis, as received from the transmitter 102, to an external electronic device 610, for the device 610 to render. The external electronic device 610 may be a display device, another type of audio/video device, or a different type of electronic device altogether.

Furthermore, the transmitter 102 includes a feedback component 609, and the receiver 104 includes a feedback component 619. The feedback components 609 may be implemented in hardware, software, or a combination of hardware and software. The feedback component 619 of the receiver 104 sends a response for each data portion or each part of each data portion received by the receiver 104 from the transmitter 102. The feedback component 619 of the transmitter 102 correspondingly waits for and receives feedback from the receiver 104 that the receiver 104 has received each data portion of each part of each data portion. As has been noted above, however, the transmitter 102 does not wait indefinitely, and where an internal timer has expired, moves on to transmission of the next frame. In one embodiment, the output of the receiving feedback component 609 can be used to force a retransmission of parts of the data portions transmitted from the transmitter 102 to the receiver 104, or data portions in their entirety.

We claim:

1. A method for transmitting real-time data from a transmitter to a receiver, comprising:
for each frame of a plurality of frames of the real-time data,
transmitting, within a time period allocated for transmission of the frame, a plurality of portions of the frame of the real-time data from the transmitter to the receiver, in order from one or more higher-priority portions to one or more lower-priority portions,
such that the transmitter waits for feedback from the receiver after transmitting each portion of the frame
until the time period allocated for transmission has expired,
such that not all of the portions of each frame may be transmitted during the time period allocated for transmission of the frame.

2. The method of claim 1, further comprising, for each frame of the plurality of frames of the real-time data,
starting a timer corresponding to the time period allocated for transmission of the frame,
wherein transmitting the plurality of portions of the frame in order from the higher-priority portions of the frame to the lower-priority portions of the frame comprises, for each portion of the frame:
determining whether the timer has indicated that the time period allocated for transmission of the frame has expired;
where the timer has not expired, transmitting the portion of the frame from the transmitter to the receiver and waiting for feedback from the receiver as to receipt of the portion of the frame; and,
where the timer has expired, proceeding to the next frame, such that any remaining portions of the frame that have not been transmitted are never transmitted.

3. The method of claim 1, further comprising, at the receiver, for each frame of the plurality of frames of the real-time data,
receiving the portions of the frame of the real-time data as transmitted by the transmitter;
sending feedback to the transmitter as each portion of the frame is received from the transmitter;
one of:
rendering the portions of the frame as the portions are received from the transmitter;
waiting until a portion of a next frame of the real-time data has begun to be received from the transmitter before rendering the portions of the frame,
wherein not all of the portions of the frame may be received from the transmitter.

4. The method of claim 1, wherein each frame of the real-time data is independent of other frames of the real-time data in that the frame is renderable independent of the other frames of the real-time data.

5. The method of claim 1, wherein one or more predetermined portions of each frame of the real-time data are independent of other portions of the frame in that the predetermined portions are renderable independent of the other portions of the frame.

6. The method of claim 1, wherein one or more predetermined portions of each frame of the real-time data are additively dependent of other portions of the frame in that the predetermined portions are renderable in an additive manner to the other portions of the frame.

7. The method of claim 1, wherein the real-time data comprises video data.

8. The method of claim 7, wherein each frame of the video data comprises the higher-priority portions including one or more of:
a control data portion; and,
an audio portion corresponding to audio information of the frame.

9. The method of claim 7, wherein each frame of the video data comprises the lower-priority portions including:
the image portions of the frame corresponding to image information of the frame, each image portion corresponding to a different rendering image quality of the frame as a whole, the image portions ordered in priority from low image quality having higher priority to high image quality having lower priority.

10. An electronic apparatus comprising:
a transmitter to transmit real-time data to a receiver, comprising:
a transmitting component to, for each frame of a plurality of frames of the real-time data, transmit within a time period allocated for transmission of the frame a plurality of portions of the frame in order from one or more higher-priority portions of the frame to one or more lower-priority portions of the frame, until the time period has expired,
a feedback component to wait for feedback from the receiver after each portion of each frame is transmitted,
wherein not all of the portions of each frame may be transmitted during the time period allocated for transmission of the frame.

11. The electronic apparatus of claim 10, wherein the transmitter further comprises a compressing component to compress the real-time data on a frame-by-frame basis.

12. The electronic apparatus of claim 10, wherein the transmitter further comprises a data-receiving component to receive the real-time data from an electronic device generating the real-time data.

13. The electronic apparatus of claim 10, wherein the transmitter further comprises a data-generating component to generate the real-time data.

14. The electronic apparatus of claim 10, further comprising the receiver communicatively connected to the transmitter, the receiver comprising:
a receiving component to, for each frame of the real-time data, receive the portions of the frame as transmitted by the transmitter; and,
a feedback component to send feedback to the transmitter as each portion of each frame is received from the transmitter,
wherein not all of the portions of each frame may be received from the transmitter.

15. The electronic apparatus of claim 14, wherein the receiver further comprises a data-transmitting component to transmit the real-time data as received from the transmitter to an electronic device rendering the real-time data.

16. The electronic apparatus of claim 14, wherein the receiver further comprises a rendering component to, for each frame of the real-time data, one of:
render the portions of the frame as the portions are received from the transmitter; and,
wait until a portion of a next frame of the real-time data has begun to be received from the transmitter before rendering the portions of the frame.

17. The electronic apparatus of claim 10, wherein:
each frame of the real-time data is independent of other frames of the real-time data in that the frame is renderable independent of the other frames of the real-time data,
one or more first portions of each frame of the real-time data are independent of second portions of the frame in that the first portions are renderable independent of the second portions of the frame, and
one or more third portions of each frame of the real-time data are additively dependent of fourth portions of the frame in that the third portions are renderable in an additive manner to the fourth portions of the frame.

18. The electronic apparatus of claim 10, wherein the real-time data comprises video data, and each frame of the video data comprises:
the higher-priority portions including:
a control data portion;
an audio portion corresponding to audio information of the frame; and,
the lower-priority portions including:
the image portions of the frame corresponding to image information of the frame, each image portion corresponding to a different rendering image quality of the frame as a whole, the image portions ordered in priority from low image quality having higher priority to high image quality having lower priority.

19. An electronic device to transmit real-time data to another electronic device, comprising:
means for compressing the real-time data on a frame-by-frame basis;
means for transmitting a plurality of portions of each frame of a plurality of frames of the real-time data within a time period allocated for transmission of the frame, in order from one or more higher-priority portions of the frame to one or more lower-priority portions of the frame, until the time period has expired;
means for waiting for feedback from the other electronic device after each portion of each frame is transmitted,
wherein not all of the portions of each frame may be transmitted during the time period allocated for transmission of the frame.

20. The electronic device of claim 19, wherein:
each frame of the real-time data is independent of other frames of the real-time data in that the frame is renderable independent of the other frames of the real-time data,
one or more first portions of each frame of the real-time data are independent of second portions of the frame in that the first portions are renderable independent of the second portions of the frame, and
one or more third portions of each frame of the real-time data are additively dependent of fourth portions of the frame in that the third portions are renderable in an additive manner to the fourth portions of the frame.
